(19) United States
(12) Patent Application Publication
(10) Pub. No.: US 2024/0268536 A1
(43) Pub. Date: Aug. 15, 2024

(54) Repeatedly Refillable and Reusable Container

(71) Applicant: Robert Wise, Penngrove, CA (US)

(72) Inventor: Robert Wise, Penngrove, CA (US)

(21) Appl. No.: 18/166,147

(22) Filed: Feb. 8, 2023

Related U.S. Application Data
(63) Continuation-in-part of application No. 18/153,629, filed on Jan. 12, 2023, now Pat. No. 11,950,679.
Application No. 18/153,629 is a continuation-in-part of application No. 17/837,890, filed on Jun. 10, 2022, now abandoned.
Application No. 17/837,890 is a continuation-in-part of application No. 16/875,100, filed on May 15, 2020, now abandoned.
Application No. 16/875,100 is a continuation-in-part of application No. 16/856,362, filed on Apr. 23, 2020, now Pat. No. 11,304,495.
Application No. 16/856,362 is a continuation-in-part of application No. 16/855,361, filed on Apr. 22, 2020, now Pat. No. 11,317,698.
Application No. 16/855,361 is a continuation-in-part of application No. 16/683,689, filed on Nov. 14, 2019, now Pat. No. 11,304,494.
Application No. 18/153,629 is a continuation-in-part of application No. 17/837,491, filed on Jun. 10, 2022.
Application No. 17/837,491 is a continuation of application No. 16/875,100, filed on May 15, 2020, now abandoned.
Application No. 18/153,629 is a continuation-in-part of application No. 17/506,942, filed on Oct. 21, 2021, now Pat. No. 11,998,101.
Application No. 17/506,942 is a continuation of application No. 17/018,826, filed on Sep. 11, 2020, now abandoned.
Application No. 17/018,826 is a continuation of application No. 16/875,100, filed on May 15, 2020, now abandoned.
(60) Provisional application No. 63/427,244, filed on Nov. 22, 2022.

(51) Int. Cl. A45D 34/04; A45D 40/04

(52) U.S. Cl. CPC A45D 34/041; A45D 40/04; A45D 2034/005; A45D 2040/0043; A45D 2040/005

(57) ABSTRACT

A repeatedly refillable and reusable container is provided. The repeatedly refillable and reusable container includes a dispenser body. The dispenser body has a formed end with sides protruding therefrom, forming a receptacle accessible via an aperture. The receptacle of the dispenser body is designed to conjoin with a material refill unit by removing an enclosure apparatus and allowing the material refill unit to couple to, refill, and dispense the material of the material refill unit. When the material of the conforming material refill unit coupled with the dispenser body is dispensed, and the material refill unit is removed, a replacement material refill unit may be coupled to the dispenser body. Whereby the coupling of the material refill unit to the dispenser body refills the dispenser rendering the dispenser body reusable by the removal of the exhausted material refill unit.

### CROSS REFERENCE TO RELATED APPLICATIONS

This application claims the benefit of U.S. Provisional application Ser. No. 17/506,942 filed on Oct. 21, 2021 which is a continuation-in-part of U.S. patent application Ser. No. 16/856,362, filed on Apr. 23, 2020, which is a continuation-in-part of U.S. patent application Ser. No. 16/855,361 filed on Apr. 22, 2020, which is a continuation-in-part of U.S. patent application Ser. No. 16/683,689 filed on Nov. 14, 2019. The above identified patent application is herein incorporated by reference in its entirety to provide continuity of disclosure.

### BACKGROUND OF THE INVENTION

The present invention relates to a repeatedly refillable and reusable container. More specifically, the present invention provides a reusable container that includes an enhanced interior volume to surface area ratio, such that a relatively higher amount of material can be stored therein.

A large number of humans use deodorant, or similar spreadable substances every day. These substances often come in plastic canisters. These canisters are meant to be used once then tossed aside. While these canisters are functional and inexpensive, they also create waste.

Plastic takes decades to decompose and all the while takes space in landfills. The trash issue in our planet is starting to reach critical levels as more and more things are made to be disposable. Items such as canisters take up even more room due to the nature of having the canister having an interior volume to hold a solution which is dispensed through the usage of the consumable product. Due to the number of canisters used these items account for a significant amount of landfill.

Consequently, there is a need in for an improvement in the art of dispenser housings in order to provide for waste reduction. The present invention substantially diverges in design elements from the known art while at the same time solves a problem many people face when using dispensers to apply substances to a desired surface, such as an individual's body. In this regard the present invention substantially fulfills these needs.

### SUMMARY OF THE INVENTION

In view of the foregoing disadvantages inherent in the known types of reusable containers now present in the prior art, the present invention provides a repeatedly refillable and reusable container wherein the same can be utilized for providing convenience for the user when refilling a container.

The present system comprises a dispenser body. The dispenser body has a formed end with sides protruding therefrom, forming a receptacle that is accessible via an aperture. The receptacle of the dispenser body is configured to conjoin with a material refill unit by removing an enclosure apparatus thereof, allowing the material refill unit to couple to, refill, and dispense the material of the material refill unit. When the material of the material refill unit is coupled with the dispenser body and the material refill unit is removed, a replacement material refill unit can be coupled to the dispenser body.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a cross-sectional view of an embodiment of the repeatedly refillable and reusable container.

FIG. 2 shows a cross-sectional view of an embodiment of the repeatedly refillable and reusable container.

FIG. 3 shows a cross-sectional view of an embodiment of the repeatedly refillable and reusable container in use.

FIG. 4 shows a cross-sectional side view of an embodiment of the repeatedly refillable and reusable container.

FIG. 5 shows a perspective view of an embodiment of the repeatedly refillable and reusable container.

FIG. 6 shows a side view of an embodiment of the repeatedly refillable and reusable container.

FIG. 7A shows a cross-sectional view of an embodiment of the repeatedly refillable and reusable container.

FIG. 7B shows a cross-sectional view of an embodiment of the repeatedly refillable and reusable container.

### DETAILED DESCRIPTION OF THE INVENTION

Reference is made herein to the attached drawings. Like reference numerals are used throughout the drawings to depict like or similar elements of the repeatedly refillable and reusable container. The figures are intended for representative purposes only and should not be considered to be limiting in any respect.

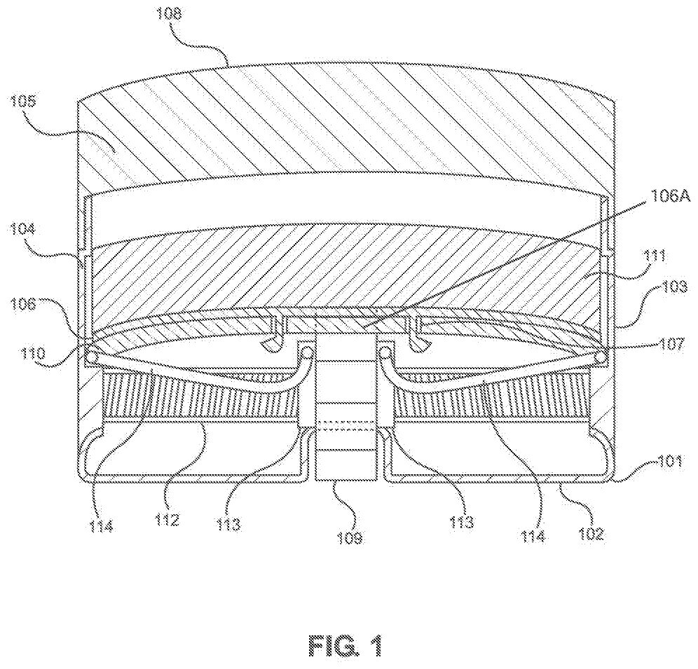

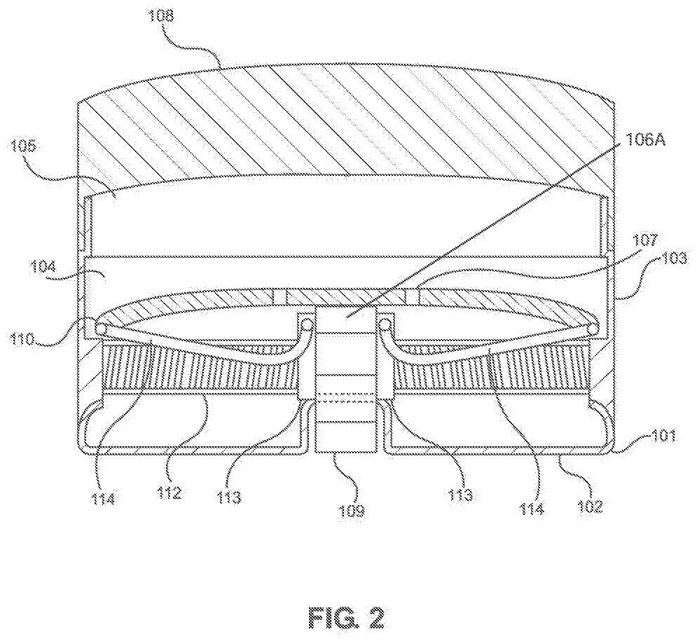

Referring now to FIGS. 1 and 2, there are shown a cross-sectional views of an embodiment of the repeatedly refillable and reusable container. The repeatedly refillable and reusable container comprises a dispenser body 101. The dispenser body 101 comprises a formed end 102 with sides 103 protruding therefrom. The sides form a receptacle 104. The receptacle 104 is accessible via an aperture 105. In the illustrated embodiment, the aperture 105 is disposed opposite the formed end 102 of the dispenser body 101. In some embodiments, at least one component of the dispenser body 101 is made of a biodegradable, compostable material.

The receptacle 104 of the dispenser body 101 is configured to conjoin with a material refill unit 106. The material refill unit 106 can be conjoined with the receptacle 104 of the dispenser body 101 when the enclosure apparatus 108 is removed. The enclosure apparatus 108 is configured to be removably affixed over the aperture 105 of the dispenser body 101, such as to prevent contamination of the materials within the receptacle 104 of the dispenser body 101. In some embodiments, at least one component of the material refill unit 106 is made from a new or recycled material including plastic, metal, bonded cellulose, cellulose pulp, organic matter, Poly Vinyl Alcohol, Poly Vinyl Succinate, Butene Diol Vinyl Alcohol Co-Polymers, Biodegradable Polymers, or any combination thereof.

The removal of a material refill unit 106 from the receptacle 104 of the dispenser body 101 allows for the insertion of a new material refill unit into the receptacle 104 of the dispenser body 101. As such, the repeatedly refillable and reusable dispenser will be able to be reused as one material refill unit becomes exhausted or otherwise expires. In the illustrated embodiment, the material refill unit 106 is configured to conjoin with a mating device 107 disposed within the receptacle 104 of the dispenser body 101.

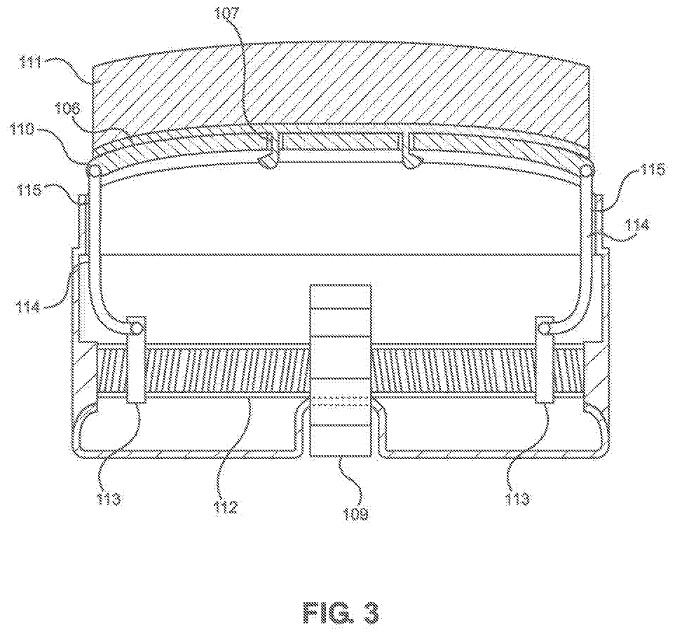

In some embodiments, the repeatedly refillable and reusable dispenser further comprises a lift apparatus component. In the illustrated embodiment, the mating device 107 is in operable connection with the lift apparatus component. The lift apparatus component is disposed in the receptacle 104 of the dispenser body 101 where the material refill unit 106 is to be coupled. The lift mechanism component is in operable connection with an actuator 109. The actuator 109 is connected to the lift mechanism such that engaging the actuator 109 will elevate the lift component, as shown in FIG. 3.

In the illustrated embodiment, the lift mechanism comprises a base 110. The base 110 is configured to couple with the material refill unit 106. As such, the base 110 will be able to press the material 111 of the material refill unit 106 through the aperture 105 of the dispenser body 101. Furthermore, in the illustrated embodiment, the lift mechanism comprises a shaft 112. The shaft 112 is in operable connection with the actuator 109, such that movement of the actuator 109 causes corresponding movement of the shaft 112, causing the material 111 of the material refill unit 106 to move either towards or away from the aperture 105 of the dispenser body 101.

In the illustrated embodiment, the shaft 112 is in operable connection with one or more movable pivot devices 113. As such, movement of the actuator 109 causes inward and outward movement of each pivot device 113 causing one or more pivotally connected mechanisms, such as yokes 114, to raise and lower the base 110 coupled to the lift mechanism. As such, a rising movement of the lift mechanism aligns the base 110 of the lift mechanism about the aperture 105 of the dispenser body 101 so to uncouple a coupling device 107 of an exhausted material refill unit 106, then couple a new conforming material refill unit to the base 110 via mating coupling devices 107.

In the illustrated embodiment, the lift mechanism is disposed within the receptacle 104 of the dispenser body 101, such that the lift mechanism includes components that are intertwined within the formed end 102 of the dispenser body 101, thereby minimizing the vertical height of the lift mechanism within the receptacle 104 of the dispenser body 101. For example, the components of the lift mechanism may be situated in the formed end 102 of the dispenser body 101 such that the lift mechanism coupled with the coupler device of the material refill unit 106, both having apertures about the actuator 109 enabling the lift mechanism with coupler devices to rest low within the dispenser body 101 enabling more material 111 within the receptacle 104.

In some embodiments, the material refill unit 106 is encased in an enclosure apparatus encapsulating the material of the conforming material refill unit, composed at least partially of a formed paper, cellulose, or other compostable material. Additionally, in some embodiments, the enclosure apparatus is temporarily attached to the conforming material refill unit, whereby removal thereof allows at least some components of the conforming material refill unit to be coupled to the base 110 of the dispenser body so to refill and dispense the material. Furthermore, in some embodiments, at least one component of the material refill unit 106 is dissolvable in a solvent. In other embodiments, the material refill unit 106 comprises a dispensing aperture exposed by removing a seal apparatus, allowing the coupling of the conforming material refill within the unit, on, in or with the base 110 of the dispenser body 101, so to dispense the material of the refill unit via the dispenser body.

Referring now to FIG. 3, there is shown a cross-sectional view of an embodiment of the repeatedly refillable and reusable container in use. In some embodiments, the repeatedly refillable and reusable dispenser further comprises one or more vertical members 115. The vertical members 115 are disposed within the receptacle 104 of the dispenser body 101 and affixed to an inner side of a perimeter of the dispenser body 101. As such, the vertical members will vertically reinforce a material of the material refill unit 106 during application of the material 111, minimizing detachment of the material refill unit 106 to the mating coupling device 107 of the base 110.

In the illustrated embodiment, the material refill unit 106, upon removal of the enclosure apparatus (108 in FIGS. 1 and 2), affixes to the open top end of the dispenser body 101, by means of a protrusion 116 that engages passages 107 defined by the base 110 of the lift mechanism. As such, the attachments will allow the contents of the material refill unit 106 to be cinched to the dispenser body 101 by engaging corresponding protrusions 116 via the passages 107 so as to secure the cap in a minimal rotation allowing refill of the material refill unit 106 with the dispenser body 101.

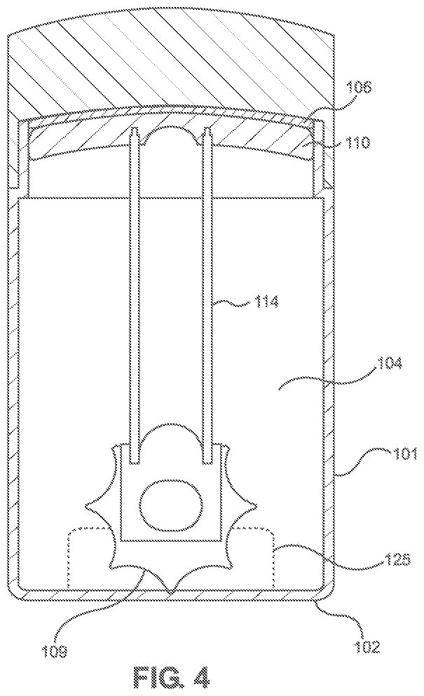

Referring now to FIG. 4, there is shown a cross-sectional side view of an embodiment of the repeatedly refillable and reusable container. The actuator 109 is selected from the group consisting of an operable dial, a knurled dial, a push plate, a ratchet, a lever, a button, a knob, a push bar, and a spline. The actuator 109 is operable from the external area of the receptacle 104 of the dispenser body 101. In the illustrated embodiment, the actuator 109 is a dial that is accessible via a cut out 125 in the formed end 102 of the dispenser body 101.

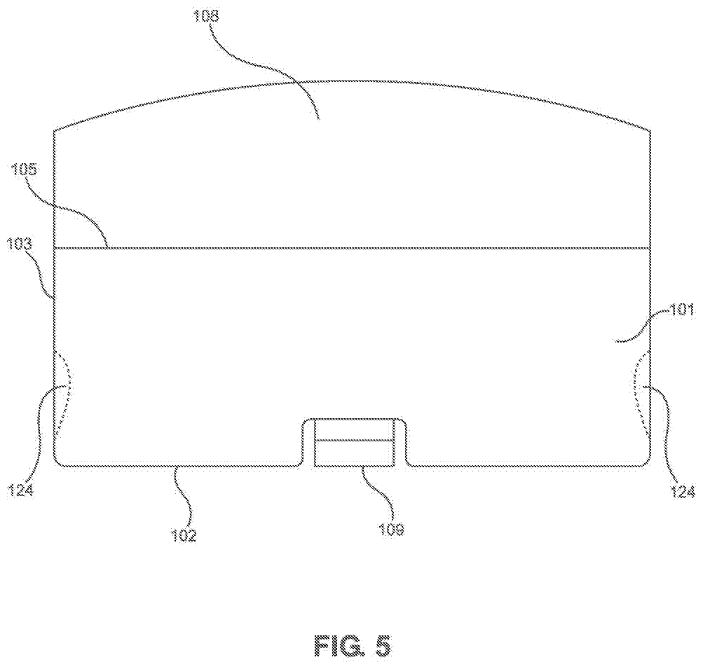

Referring now to FIG. 5, there is shown a perspective view of an embodiment of the repeatedly refillable and reusable container. In the illustrated embodiment, the repeatedly refillable and reusable dispenser further comprising recesses 124 disposed on an exterior of the sides 103 of the dispenser body 101. The recesses 124 provide for added grip using a thumb on one side and fingers or knuckles on the opposite side within the recesses 124, enhancing the grip of the dispenser body 101.

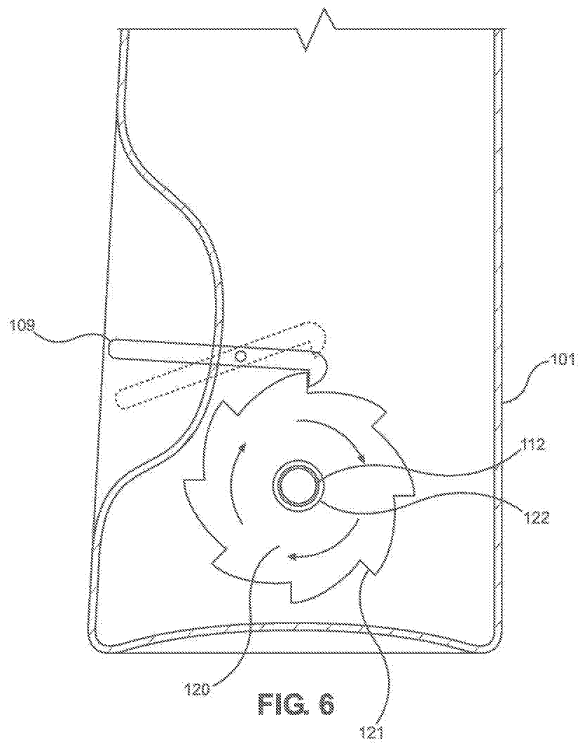

Referring now to FIG. 6, there is shown a side view of an embodiment of the repeatedly refillable and reusable container. In the illustrated embodiment, the actuator 109 is in operable connection with dial 120 which further comprises a sprocket with cogs 121, whereby activation of the actuator 109 allows incremental movement of one or more threaded shafts 112 operably connected to the dial 120, thereby enabling the lift mechanism to rise within the receptacle of the dispenser body 101. As shown, the dial 120 comprises one or more threaded shafts 112 having a spring 122 providing spring tension so to rotate and cause the lift mechanism to rise upon activation of the actuator 109. The spring 122 causes the lift mechanism to automatically rise, as each cog 121 is released when activation of the actuator 109 (shown as an external control lever) causes the lift mechanism to recoil into the interior volume of the dispenser body 101 upon a conforming refill material unit being coupled and inserted into the dispenser body 101.

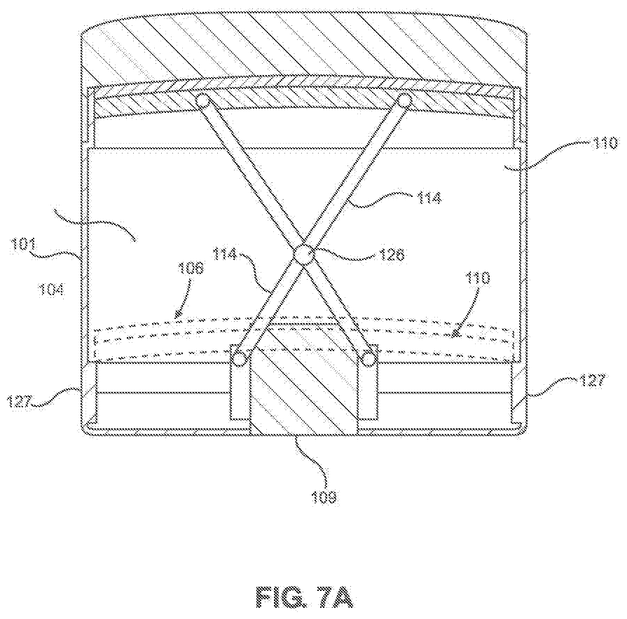

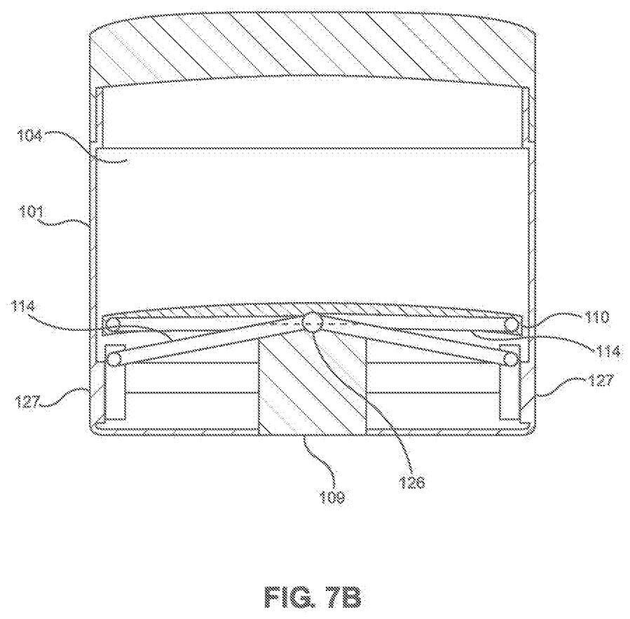

Referring now to FIGS. 7A and 7B, there are shown cross-sectional views of an embodiment of the repeatedly refillable and reusable container. In the illustrated embodiment, the lift mechanism is intertwined on either side of the actuator 109, wherein the lift mechanism includes elongated pivoting yokes 114 having a pivot 126 towards a center of the receptacle 104 of the dispenser body 101, which extends the elevation of the lift base 110 within the dispenser body 101, as the moveable pivot blocks move inward, allowing added volume of material within, on or in the dispenser body receptacle. In some embodiments, the lift mechanism components and actuator 109 comprise a single unit that is received through an aperture 105 of the dispenser body 101, with a means of conjoining within the receptacle 104 of the dispenser body 101. In the illustrated embodiment, the actuator 109 and lift mechanism snap into a pair of saddles 127 disposed on opposing sides of the dispenser body 101.

The repeatedly refillable and reusable dispenser may be made of any suitable material. In one embodiment, at least one component is made with a biodegradable compostable material. In another embodiment, at least one component is made with a water dissolving material. Additionally, at least one component may be made of a new or recycled material selected from the group consisting of plastic, metal, organic compound, cellulose, bonded paper and a combination thereof.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The invention claimed is:

1. A repeatedly refillable and reusable dispenser, comprising:
a dispenser body having a formed end with sides protruding therefrom, whereby a receptacle accessible via an aperture of the open end of the dispenser body;
the receptacle of the dispenser body is configured to couple with a conforming material refill unit by removing an enclosure apparatus thereof allowing the conforming material refill unit to couple to, refill, and dispense a material of the conforming material refill unit;
whereby when the material of the conforming material refill unit coupled with the receptacle of the dispenser is dispensed, all or part of the conforming material refill unit is removed, and a replacement conforming material refill unit is coupled to the receptacle;
wherein the conforming material refill unit comprises the aperture of the dispenser body exposed by removing a seal apparatus, allowing the coupling of the material within the conforming material refill unit, on, in or with a mating receptacle of the dispenser body, so to dispense the material of the conforming material refill unit via the dispenser body;
wherein the conforming material refill unit is coupled with the receptacle of the dispenser body; and
whereby the coupling thereof refills the dispenser rendering the dispenser body reusable by removal of conforming exhausted material refill unit.

2. The repeatedly refillable and reusable dispenser of claim 1, wherein the conforming material refill unit is encased in the enclosure apparatus encapsulating the material of the conforming material refill unit, the material is selected from the group consisting of at least partially of a formed paper, a cellulose, a bio BPS or Bisphenol S, or a compostable material.

3. The repeatedly refillable and reusable dispenser of claim 1, wherein the enclosure apparatus is temporarily attached to the conforming material refill unit, wherein removal thereof allows at least one or more components of the conforming material refill unit coupled to one or more mating devices of the dispenser body so to refill and dispense the material.

4. The repeatedly refillable and reusable dispenser of claim 3, wherein at least one or more components of the conforming material refill unit is dissolvable in a solvent.

5. The repeatedly refillable and reusable dispenser of claim 1, wherein at least one or more components of the dispenser body is made of a biodegradable and compostable material.

6. The repeatedly refillable and reusable dispenser of claim 1, further comprising a lift apparatus component within the receptacle of the dispenser body that aligns and couples with the conforming material refill unit.

7. The repeatedly refillable and reusable dispenser of claim 6, wherein movement of the actuator causes the material of the conforming material refill unit to move within the dispenser body via the lift mechanism.

8. The repeatedly refillable and reusable dispenser of claim 7, wherein the lift mechanism functions via an actuator operable external of the dispenser body selected from the group consisting of at least an operable dial, a knurled dial, a push plate, a ratchet, a lever, a button, a knob, a push bar, or a spline.

9. The repeatedly refillable and reusable dispenser of claim 7, wherein the actuator is connected to a lift mechanism having a base, wherein the base is configured to couple with conforming material refill unit when about the aperture of the dispenser body, the conforming material refill unit coupled with, in or on the dispenser, refilling the dispenser.

10. The repeatedly refillable and reusable dispenser of claim 1, wherein the actuator further comprises a shaft attached thereto, wherein movement of the actuator causes corresponding movement of the shaft, causing the material of the conforming material refill unit to move either towards or away from the aperture of the dispenser body.

11. The repeatedly refillable and reusable dispenser of claim 1, wherein the actuator comprises the shaft coupled to one or more moveable pivot devices, wherein movement of the actuator causes inward and outward movement of each of the one or more moveable pivot devices causing one or more pivotally connected mechanisms to raise and lower the lift base coupled to the lift mechanism.

12. The repeatedly refillable and reusable dispenser of claim 11, wherein a rising movement of the lift mechanism aligns the lift base of the lift mechanism about the aperture of the dispenser body so to uncouple a coupling device of the exhausted conforming material refill unit, then couple the replacement material refill unit to the lift base via one or more mating coupling devices.

13. (canceled)

14. The repeatedly refillable and reusable dispenser of claim 1, further comprising one or more vertical members disposed within an interior volume of the dispenser body affixed to an inner side of a perimeter of the dispenser body, so to vertically reinforce the material during application, minimizing detachment of the material to the coupling device of the conforming material refill unit.

15. The repeatedly refillable and reusable dispenser of claim 12, wherein at least one component of the conforming material refill unit includes a new or recycled material selected from the group consisting of plastic, metal, bonded cellulose, cellulose pulp, organic matter, Poly Vinyl Alcohol, Poly Vinyl Succinate, Butene Dial Vinyl Alcohol Co-Polymers, Biodegradable Polymers, or any combination thereof.

16. The repeatedly refillable and reusable dispenser body of claim 1, wherein conforming material refill unit, upon removal of the units enclosure apparatus, affixes to the open top end of the dispenser body, by means for protrusion engaging via passages, allowing the contents of the conforming material refill unit to be cinched to the dispenser body by engaging corresponding prongs via the passages so to secure a cap in a minimal rotation allowing refill of the conforming material refill unit with the dispenser body.

17. A repeatedly refillable and reusable dispenser, comprising:
a formed dispenser housing creating an inner receptacle;
whereby a mating material refill unit couples to the dispenser housing;
whereby the dispenser housing connects to a power source which enables a mechanism to direct and emit a material within the material refill unit via an external aperture of the dispenser;
wherein the material refill unit refills a dispenser body at least once, enabling repeated use of at least the dispenser body; and
wherein the material refill unit comprises the external aperture of the dispenser body exposed by removing a seal apparatus, allowing coupling of the material refill unit within the material refill unit, on, in or with the dispenser body, so to dispense the material of the material refill unit via the dispenser body.

18. The repeatedly refillable and reusable dispenser of claim 17, wherein the power source directs a varied material within the material refill unit to emit the material.

19. A repeatedly refillable and reusable dispenser, comprising:
a dispenser body having a base with an arising perimeter, the dispenser body having a receptacle within the dispenser body accessible via an aperture;
a lift mechanism intertwined within the base of the dispenser body, moveably affixed to the receptacle;
wherein the lift mechanism is operable via an actuator disposed external of the dispenser body;
wherein the lift mechanism receptacle within the dispenser includes a coupling device configured to couple to a mating coupling device of a conforming material refill unit;
wherein the conforming material refill unit coupled with the dispenser body receptacle moves towards or away from the aperture of the dispenser body via activation of the lift mechanism actuator;
wherein an exhausted conforming material refill unit uncouples from the coupling device of the lift mechanism receptacle, enabling coupling of a conforming replacement material refill unit to the lift mechanism receptacle, retracting all or in part the material of the conforming material refill unit within, on to or about the dispenser body, enabling repeated use of the dispenser body; and
wherein the conforming material refill unit further comprises dispensing via the dispenser body aperture exposed by removing a seal apparatus, wherein the mating coupling device of the material refill unit with the dispenser body receptacle enables a base moveably affixed to the lift mechanism to press the material through the dispenser body, dispensed via the aperture thereof, all or in part, as the actuator is activated external of the dispenser body, as needed, the seal apparatus affixed to the dispenser body in between dispenses of the material, the seal apparatus encloses and seals the material within the dispenser body between uses.

20. The repeatedly refillable and reusable dispenser of claim 19, wherein the lift mechanism includes the actuator selected from the group consisting of a knurled dial, a dial, a sprocket, a lever, a spline, a knob, a button, or a push plate.

21. The repeatedly refillable and reusable dispenser of claim 19, wherein the actuator includes a threaded shaft coupled with one or more moveable pivot devices moveably attached thereto, whereby movement of the actuator causes the one or more moveable pivot devices to move along one or more threaded shafts, which causes one or more support yokes connected to the one or more moveable pivot devices to raise and lower.

22. The repeatedly refillable and reusable dispenser of claim 19, wherein the one or more support yokes are coupled to the one or more moveable pivot devices on one end and a lift base on an opposite end, wherein the support yokes enable the lift base to rise and align through the aperture of the dispenser body enabling the uncoupling of the exhausted material refill unit then coupling a full material refill unit, retracting the material refill unit into the dispenser body receptacle.

23. The repeatedly refillable and reusable dispenser of claim 22, wherein coupling of the coupling device of the conforming material refill unit to the coupling device in, on or about the dispenser body temporarily engages the conforming material refill unit to the lift base within the dispenser.

24. The repeatedly refillable and reusable dispenser of claim 23, wherein the lift mechanism is disposed within an interior volume of the dispenser body, such that the lift mechanism includes components that are intertwined within the lift base of the dispenser body, thereby minimizing a vertical height of the lift mechanism within the interior volume of the dispenser body.

25. The repeatedly refillable and reusable dispenser of claim 24, wherein the components of the lift mechanism are situated in the lift base of the dispenser body such that the lift mechanism coupled with a coupler device of the material refill unit, both having an aperture about the actuator mechanism enabling the lift mechanism with coupler devices to rest low within the dispenser enabling more of the material within the dispenser body receptacle.

26. The repeatedly refillable and reusable dispenser of claim 19, further comprising recesses disposed on an exterior of the dispenser body, thereby adapted to allow added grip using a thumb on one side and fingers or knuckles on the opposite side within the recesses, enhancing the grip of the dispenser body.

27. The repeatedly refillable and reusable dispenser of claim 19, further comprising the component is at least one made with a biodegradable and compostable material.

28. The repeatedly refillable and reusable dispenser of claim 27, further comprising the at least one component is made with a water dissolving material.

29. The repeatedly refillable and reusable dispenser of claim 28, further comprising the at least one component is made of a new or recycled material selected from the group consisting of plastic, metal, organic compound, cellulose, bonded paper, or any combination thereof.

30. The repeatedly refillable and reusable dispenser of claim 19, wherein the material refill unit is made of a material selected from the group consisting of Poly Vinyl Succinate, Poly Vinyl Alcohol, Butene Dial Vinyl Alcohol Co-Polymer, Biodegradable Polymers, or bonded Cellulose.

31. (canceled)

32. The repeatedly refillable and reusable dispenser of claim 19, wherein the actuator comprises a dial which further comprises a sprocket with cogs, wherein activation of an external control mechanism allows incremental movement of one or more threaded shafts operably connected to the dial, thereby enabling the lift mechanism to rise within the interior volume of the dispenser body.

33. The repeatedly refillable and reusable dispenser of claim 32, wherein the dial comprises the one or more threaded shafts having a spring providing spring tension so to rotate and cause the lift mechanism to rise upon activation of the external control mechanism.

34. The repeatedly refillable and reusable dispenser of claim 33, wherein the spring causes the lift mechanism to automatically rise, as each cog is released when activation of the external control mechanism lever causes the lift mechanism to recoil into the interior volume of the dispenser body upon the conforming refill material unit is coupled and inserted into the dispenser body.

35. The repeatedly refillable and reusable dispenser of claim 19, wherein the lift mechanism is intertwined on either side of the actuator, wherein the lift mechanism includes elongated pivoting yokes having a pivot towards a center of the interior volume of the dispenser body, which extends the elevation of the lift base within the dispenser body, as the moveable pivot blocks move inward, allowing added volume of material within, on or in the dispenser body receptacle.

36. The repeatedly refillable and reusable dispenser of claim 19, wherein the lift mechanism components and the actuator comprises the material refill unit that is received through the aperture of the dispenser body base, with a means for conjoining within the dispenser body receptacle.

37.-38. (canceled)
